(19) United States
(12) Patent Application Publication
(10) Pub. No.: US 2004/0258192 A1
(43) Pub. Date: Dec. 23, 2004

(54) Mitigation of steam turbine stress corrosion cracking

(75) Inventors: Thomas Martin Angeliu, Clifton Park, NY (US); Peter Louis Andresen, Schenectady, NY (US); Young-Jin Kim, Clifton Park, NY (US); Francis Peter Ford, Rexford, NY (US)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/461,903

(22) Filed: Jun. 16, 2003

(51) Int. Cl. G21C 9/00

(52) U.S. Cl. 376/305

(57) ABSTRACT

A process for mitigating stress corrosion cracking of steam turbine components in a steam environment, includes coating the metal components of the steam turbine with a noble metal. The noble metal is preferably a platinum group metal selected from the group consisting of platinum, palladium, osmium, rhodium, ruthenium, iridium, and combinations comprising at least one of the foregoing platinum group metals. In another embodiment, the process comprises coating the metal components with a platinum group metal and introducing a reductant into the steam to mitigate the stress corrosion cracking. Also disclosed herein is a steam turbine comprising a metal component having a surface coated with a platinum group metal.

### BACKGROUND

This disclosure generally relates to steam turbines, and more particularly, to methods for mitigating stress corrosion cracking of metal turbine components exposed to water, steam, and/or condensate in the steam turbine.

Steam turbine power systems use a medium such as water or another suitable chemical with boiling points and latent heat values appropriate for the operational temperatures of the system. The medium is generally heated in a separate heat source such as a boiler by using directed solar radiation, burning of fossil fuel, nuclear radiation, and/or geothermal energy. The energy is then transferred from the heat source to the turbines through high-pressure steam that in turn powers the turbines. The steam builds a pressure that turns a turbine that operates an electromagnetic generator producing electricity.

A common type of steam turbine system includes a plurality of turbines in the form of a high-pressure turbine, an intermediate pressure turbine, and a low-pressure turbine. The turbines can be in a closed loop, which includes a steam generator for supplying steam to the high-pressure turbine and a condenser that receives the low-pressure turbine discharge. Water from the condenser is then provided back to the heat source, i.e., steam generator, for reuse and is generally treated prior to reuse so as to remove impurities. The steam turbine extracts energy from the steam to power an electrical generator, which produces electrical power. Alternatively, low to medium pressure steam, after passing through the turbines, can be directed to an intermediate temperature steam distribution system, e.g., a heat exchanger, that delivers the steam to a desired industrial or commercial application such as is desired for combined heat and power applications.

Each turbine generally includes a fixed partition (i.e., nozzles) and a plurality of turbine buckets (i.e., blades) mounted on rotatable turbine wheels. The buckets are conventionally attached to the wheels by a dovetail connection. Dovetail attachment techniques between turbine buckets and turbine rotor wheels for steam turbines are well known in the art. A number of different types of dovetails may be employed. For example, a finger-type dovetail is often used to secure the buckets and rotor wheel to one another. In that type of dovetail, the outer periphery of the rotor wheel has a plurality of axially spaced circumferentially extending stepped grooves for receiving complementary fingers on each of the bucket dovetails when the buckets are stacked about the rotor wheel. Pins are typically passed through registering openings of the dovetail fingers of each of the wheel and bucket dovetails to secure the buckets to the wheel. Another type of dovetail is a tangential entry dovetail. The turbine wheel and bucket dovetails have a generally complementary pine tree configuration. In any event, the dovetail connections between the buckets and wheels are highly stressed and, after years of operation, tend to wear out and crack.

Cracking of the various components in low-pressure turbines, such as at the dovetail connection, is believed to be related to a phenomena commonly referred to as stress corrosion cracking (SCC). Stress levels within the component can accelerate, SCC, such as the stress present in the hook fillet regions of typical dovetail configurations. Normally, these stresses are acceptable but with contaminated steam and age, cracks can initiate and, if left undetected, may grow to a depth that will cause failure of the wheel hooks. Moreover, the steam at the low-pressure end of the turbine, contaminated or otherwise, is at a lower temperature having been cooled during passage through the turbine. As a result, water condenses therefrom more readily and as a result, the steam at the low pressure end of the steam turbine is fairly saturated with water. Because of exposure to the steam, the transfer of energy by impact of the wet steam by itself on the turbine blades is greater at the low-pressure end of the turbine than that at the high-pressure end, resulting in greater stress applied to the turbine components.

The steam environment existing in the steam turbine considerably affects the rate of progress of SCC. As used herein, the term “steam environment” refers to an environment in which water droplets, water films, or capillary condensates exist. The reason for this is that chemical factors are involved in stress corrosion cracking so that stress corrosion cracking is promoted in certain specific temperature regions dependent on the relationship between the steam constituents and the chemical properties of the rotor material. Because of the mass and the rotational speed of a turbine, e.g., typically on the order of 3,600 revolutions per minute (rpm), significant damage to the turbine, its housing and surrounds, as well as injury to turbine operators, can occur should cracks develop in the wheel dovetail sufficiently to permit one or more of the buckets to fly off the rotor wheel. In extreme cases, all the hooks will fail and buckets will fly loose from the rotor. Long experience with bucket-to-wheel dovetail joints has generally indicated that the wheel hooks crack but that the bucket hooks do not crack.

At the present time, Cr—Mo—Ni—V martensitic steel is typically used for various low-pressure steam turbine components. Prior attempts to minimize stress corrosion cracking of these types of metals include lowering the electrochemical corrosion potential by adding reducing agents such as hydrazine to the steam. These additives scavenge oxygen from the steam, which is considered by many to be a one of the primary causes of stress corrosion cracking. Lowering oxygen lowers the so-called electrochemical corrosion potential. The electrochemical corrosion potential is a measure of the thermodynamic tendency for corrosion phenomena to occur, and is a fundamental parameter in determining rates of stress corrosion cracking.

In addition to the use of additives, shot peening various metal components of the steam turbine most prone to stress corrosion cracking can be used to put the surface into compression, which is also believed to help mitigate stress corrosion cracking. Other methods of reducing stress corrosion cracking include changing the composition of the steel. For example, recently Fe-12Cr alloys have been employed for the low pressure steam turbine components in the attempt to mitigate stress corrosion cracking. Reducing the stress on the component through design and operational changes can also reduce stress corrosion cracking.

There still remains a need for improvement in mitigating stress corrosion cracking of steam turbine components in steam environments.

### BRIEF SUMMARY

Disclosed herein is a method for mitigating stress corrosion cracking in a surface of a metal component adapted for use in steam turbines, comprising creating a catalytic site on the surface of the metal component; and exposing the surface of the metal component to a steam environment, wherein the surface comprises catalytic sites.

In another embodiment, a method for mitigating stress corrosion cracking in a surface of a metal component adapted for use in low pressure steam turbines, comprising injecting a solution or a suspension containing nanoparticles of a platinum group, an alloy of the platinum group metal, a compound of the platinum group metal, or a combination thereof into low steam environment; forming catalytic sites in the low steam environment; and reducing a concentration of oxidant in the low steam environment.

Also disclosed herein is a steam turbine comprising components formed from a metal having a surface comprising catalytic sites for reducing a concentration of an oxidant in a steam environment.

The above described and other features are exemplified by the following detailed description and figures.

### BRIEF DESCRIPTION OF FIGURES

FIG. 1 is a fragmentary perspective view of a turbine rotor wheel illustrating a finger-type dovetail connection with a turbine wheel bucket;

FIG. 2 is a perspective view illustrating a fir tree dovetail connection for attaching a steam turbine blade to a turbine wheel bucket;

FIG. 3 is a side elevational view of a compact tension specimen depicting relative dimensions for measuring crack growth rate;

FIG. 4 graphically summarizes measured crack growth rates as a function of corrosion potential for uncoated and noble metal coated NiCrMoV compact tension specimens at two strength levels under low and high corrosion potential conditions;

FIG. 5 graphically illustrates measured crack lengths with time for uncoated NiCrMoV compact tension specimens at two strength levels under low and high corrosion potential conditions;

FIG. 6 graphically illustrates measured crack lengths with time for noble metal coated NiCrMoV compact tension specimens at two strength levels under low and high corrosion potential conditions; and

FIG. 7 graphically illustrates measured crack lengths with time for noble metal coated NiCrMoV compact tension specimens at two strength levels under low and high corrosion potential conditions.

### DETAILED DESCRIPTION

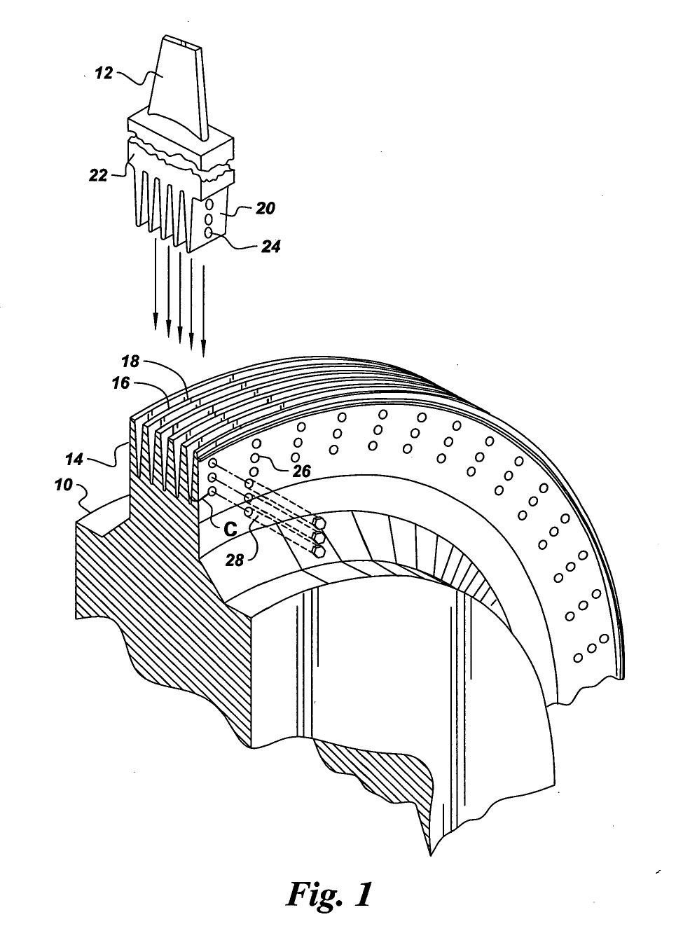

Referring now to the drawing figures, and in particular to FIG. 1, there is a fragmentary perspective view of an exemplary rotor suitable for use in a steam turbine, the steam turbine having a number of stages wherein each stage includes a rotor wheel 10 mounting a plurality of buckets 12. Each rotor 10 includes a dovetail 14 comprised of a plurality of circumferentially extending, radially outwardly projecting fingers 16 defining grooves 18 therebetween. The grooves 18 receive complementary-shaped dovetail fingers 20 forming part of the bucket dovetail 22. As illustrated, the bucket dovetail 22 has a plurality, three being illustrated, of axially registering holes 24 through each finger 20 which, when the bucket dovetail 22 is applied to the dovetail 14 of wheel 10, register with corresponding openings 26. Pins 28 are used to secure the buckets 12 to the wheel 10. It will be appreciated that the bucket dovetails are stacked against one another to form a circumferential array of buckets about the wheel and, in use, lay in the hot fluid path of the turbine, e.g., the steam path of a steam turbine.

Also illustrated in FIG. 1 is a crack C in dovetail 14 resulting from occurrence of one or more of the aforementioned failure mechanisms, e.g., stress corrosion. Because the dovetail 14 lies in the high stress area of the wheel during use, failure has been found to invariably occur in the dovetail 14 before any failure occurs in the remaining radially inward portions of the wheel 10.

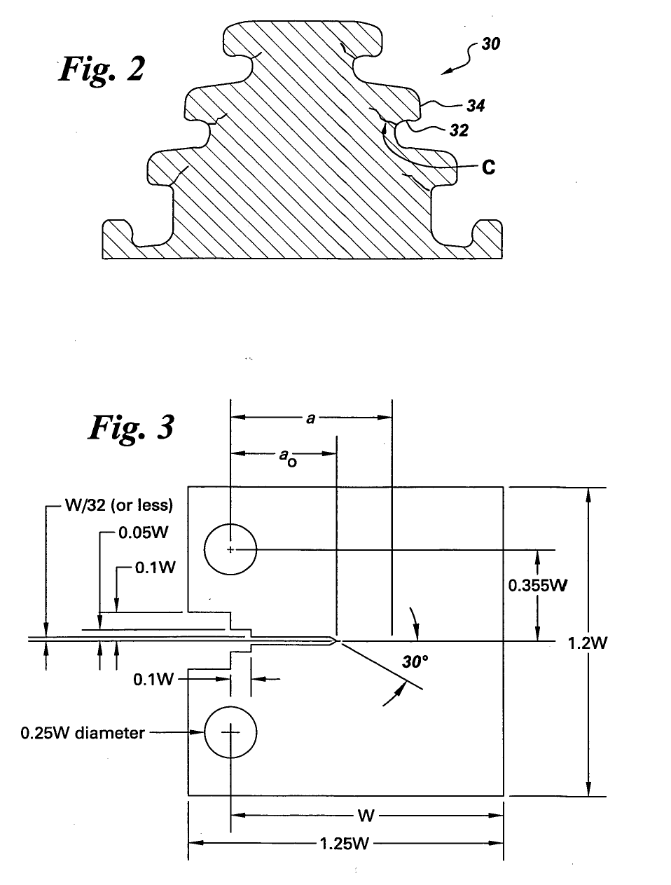

FIG. 2 illustrates an alternative dovetail connection commonly referred to as a fir tree or Christmas tree type dovetail connection and is generally designated by reference numeral 30. The fir tree dovetail design permits attachment of the turbine blade to the turbine wheel bucket. The fir tree dovetail connection generally includes a plurality of load bearing surfaces 32 and lands or flats 34. During prolonged use, cracks C tend to form over time in regions of high stress as shown.

Disclosed herein is a process for mitigating stress corrosion cracking of steam turbine components, such as at the dovetail crack location C described above, that may occur over time upon exposure to the steam environment produced in the steam turbine. The process includes coating the steam turbine components most prone to stress corrosion cracking with a catalytic amount of a noble metal. Advantageously, it has been found that coating the steam turbine components with the noble metal as will be described herein, reduces the amount of oxygen in the steam environment, which results in lowering the corrosion potential below a critical value believed to be necessary for stress corrosion related cracking.

In many components and locations of a steam turbine, a one-time or periodic application of the noble metal is sufficient to achieve and maintain a catalytic surface. The noble metal catalyzes the recombination of oxygen present in the steam environment in conjunction with a reducing agent. If there are already sufficient amounts of reducing agent in the steam environment, only a trace amount of the noble metal to the regions of concern is employed, thereby providing an economical and efficient solution for mitigating stress corrosion cracking.

The steels employed for steam turbine rotors are generally martensitic steels based on NiCrMoV alloys due to their high strength in combination with some corrosion resistance. Martensitic steels are magnetic and like carbon steels can be strengthened and hardened by heat treatment. Heat treatment of martensitic steels generally results in a higher strength with a corresponding proportional diminution of ductility with increasing hardness. In the hardened condition, there is increasingly less resistance to stress corrosion cracking and hydrogen induced cracking.

A catalytic layer of a platinum group metal is preferably deposited onto the metal alloy for those components employed for the rotors and/or bucket components of the steam turbine. Suitable metal alloy compositions include alloys of carbon steel, alloy steel, stainless steel, nickel-based alloys, cobalt-based alloys, and the like. The noble metal coating catalyzes the stoichiometric combination of reducing species, such as hydrogen, with oxidizing species, such as oxygen, that are present in the steam, water and/or condensate. Such catalytic action at the surface of the alloy can lower the corrosion potential of the alloy below a critical corrosion potential where stress corrosion cracking is minimized. As a result, the efficacy of hydrogen additions to the steam environment in lowering the electrochemical potential of components, made from the, alloy and exposed to the injected water is increased many fold.

It has been found that it is possible to provide effective catalytic activity on martensitic metal alloy surfaces if the metal substrate of such surfaces contains a catalytic layer of a platinum group metal. Platinum group metals providing effective catalytic activity include platinum, palladium, ruthenium, iridium, osmium, rhodium, and combinations comprising at least one of the foregoing platinum group metals. Furthermore, relatively small amounts of the platinum group metal are sufficient to provide an effective catalytic layer having effective catalytic activity at the surface of the metal substrate. For example, it has been found that a solute in an alloy of at least about 0.01 weight percent, preferably at least 0.1 weight percent provides a catalytic layer sufficient to lower the corrosion potential of the coated steam turbine component below the critical potential. The solute of a platinum group metal can be present up to an amount that does not substantially impair the metallurgical properties, including strength, ductility, and toughness of the alloy. The solute can be provided by methods known in the art, for example by addition to a melt of the alloy, or by surface alloying.

In addition, a coating of the platinum group metal, or a coating of an alloy comprised of a solute of the platinum group metal as described above, or bulk alloying of platinum group metals, provides a catalytic layer and catalytic activity at the surface of the metal. The catalytic activity can provide a lowering of the corrosion potential over coating discontinuities by reducing oxidants over the exposed areas. It is believed that coating discontinuities leaving exposed metal surface up to about 100 microns from the nearest coating are protected by the catalytic layer. Suitable coatings can be deposited onto the steam turbine components, ex situ or in situ, by methods well known in the art for depositing continuous or substantially continuous coatings on metal substrates, such as by plasma spraying, flame spraying, chemical vapor deposition, physical vapor deposition processes such as sputtering, welding such as metal inert gas welding, electroless plating, electrolytic plating, and the like. In a preferred embodiment, electroless plating is employed to coat the noble metal by injecting a noble metal containing solution into the steam turbine during operation thereof. The primary mechanism of the deposition comprises oxidizing water and reducing the metal catalyst on the surface of the metal component, e.g., 2H₂O→4H⁺+O₂+4e⁻; and Pt⁺⁴+4e→Pt.

Because very small surface concentrations are adequate to provide the catalytic layer and reduce the corrosion potential of the metal, the processing, physical metallurgical or mechanical properties of the alloys, and components formed therefrom are not significantly altered. Moreover, lower amounts of reducing species such as hydrogen are effective to reduce the corrosion potential of the metal components below the critical potential, because the efficiency of the combination of oxidizing and reducing species is increased manyfold by the catalytic layer. For example, the crack growth rate of a steam turbine component having a catalytic layer of the platinum group metal, and exposed to low temperature steam comprised of 8.2 part per million (ppm) oxygen can be reduced to 0.007 inches per year by the addition of 1.26 ppm hydrogen to the water. In contrast, the crack growth rate of the same component not having a catalytic layer of a platinum group metal exposed to low temperature water (150° C.) comprised of 200 ppb oxygen has a crack growth rate of 0.35 inches per year. Lowering the crack growth rate to 0.003 inches per year can be achieved upon addition of 95 ppb hydrogen to the steam. However, this amount of hydrogen greater than about 300 percent more than the amount of hydrogen needed to achieve similar results with a noble metal treated component.

Reducing species that can be combined with the oxidizing species in the steam environment are provided by conventional means known in the art. Briefly described, reducing species such as hydrogen, ammonia, or hydrazine are injected into the heat source (e.g., boiler), the boiler exhaust, the condenser of the steam, into the various stages of the steam turbine, or the like. Recirculated water can then be sampled to determine the level of reducing species. If necessary, additional reducing species are injected into the steam turbine to reduce the corrosion potential of the components exposed in the steam environment below the critical potential.

The platinum group metal is preferably introduced into the steam turbine as organometallic, organic, or inorganic compounds or as nanoparticles comprising of one or more of platinum group metals with at least one dimension less than 100 nanometers (nm). The platinum group metal may also be alloyed into the, metal of interest during fabrication by processes including casting and powder metallurgy. The compounds may be soluble or insoluble in water (i.e., may form solutions or suspensions in water and/or other media such as alcohols and/or acids). Examples of preferred platinum group metal compounds which may be used are palladium acetyl acetonate, palladium nitrate, palladium acetate, platinum acetyl acetonate, hexahydroxyplatinic acid, Na₂Pt(OH)₆, Pt(NH₃)₄(NO₃)₂, Pt(NH₃)₂(NO₃)₂, K₃Ir(NO₂)₆, Na₃Rh(NO₂)₆ and K₃Rh(NO₂)₆. Other examples include, but are not intended to be limited to, platinum (IV) oxide (Pt(IV)O₂), platinum (IV) oxide hydrate (Pt(IV)O₂.xH₂O, wherein x is 1 to 10), rhodium(II) acetate (Rh(II)ac₂), rhodium (III) nitrate (Rh(III)(NO₃)₃), rhodium (III) oxide (Rh(III)₂O₃), rhodium (III) oxide hydrate (Rh(III)₂O₃.xH₂O, wherein x is 1 to 10), rhodium (III) phosphate (Rh(III)PO₄), and rhodium (III) sulphate (Rh(III)₂(SO₄)₃).

Examples of mixtures of the compounds that may by used are mixtures containing platinum and iridium, platinum and rhodium, or the like. Use of such mixtures results in incorporation of noble metals on the oxidized component surface of both noble metals. The presence of iridium or rhodium with the platinum has been found to provide long-term durability. It has been found that a combination of about 40 to about 80 ppb Pt and about 10 to about 35 ppb Rh, for example, provides good adherent properties over extended periods of time.

Thus, although it is known that the conventional injection of higher concentrations of hydrogen into the steam environment of the steam turbine can be effective in reducing stress corrosion cracking, it has also been found that the effectiveness of the reducing species, e.g., hydrogen, in this role is limited by the sluggish reaction and combination of hydrogen and oxygen to produce water. What has now been found and demonstrated experimentally through catalyzed hydrogen water chemistry is that an improvement in the rate of combination of hydrogen and oxygen on components exposed to the steam environment can be achieved at reduced concentrations of hydrogen by increasing the catalytic activity at the surface of the martensitic component. The catalytic layer of the platinum group metal reduces the corrosion potential of the metal component below the critical potential, even in the presence of higher oxygen concentrations that cannot be tolerated in the absence of, catalysts.

The following examples are provided to illustrate some embodiments of the present disclosure. They are not intended to limit the disclosure in any aspect.

### EXAMPLE 1

In this example, crack growth rate was determined for noble metal coated and uncoated NiCrMoV martensitic steel compact tension specimens having 0.2% yield strengths of 120 Ksi and 152 Ksi. A constant load of 60 Ksi-in^{0.5} was applied to the compact tension specimens during the period of testing. The specimens were exposed to high purity water at a temperature of 150° C. Oxygen gas, or oxygen and hydrogen gases, were dissolved into the water at specific concentrations and at specific times to vary the corrosion potential. The dimensions of the compact tension specimens are shown in FIG. 3, wherein the compact tension specimen width dimension (W) was 1 inch and the thickness was 0.5 inches; a compact tension specimen having these dimensions is commonly referred to as 0.5T specimen.

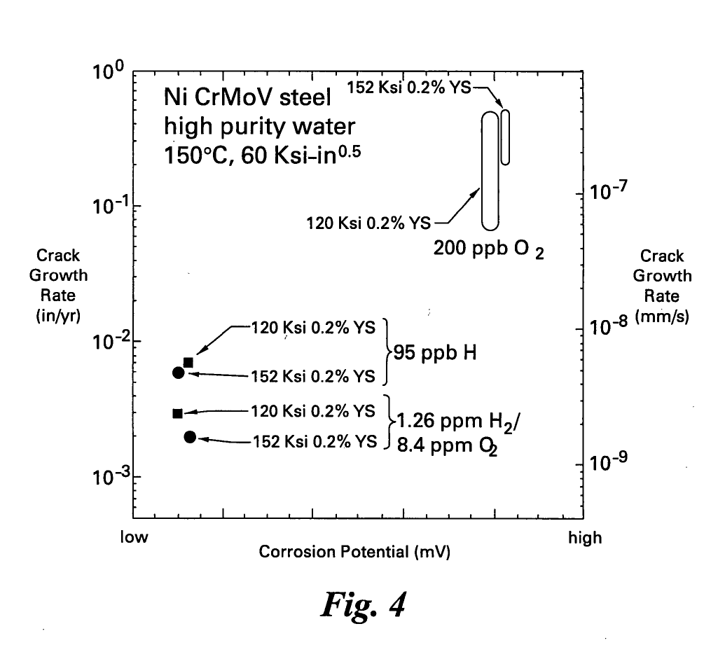

Table 1 summarizes the crack growth rate results (inches per year) for the various noble metals treated and untreated compact specimens. FIG. 4 graphically summarizes the data obtained.

TABLE 1

| | 120 Ksi 0.2% Yield | | | |
|---|---|---|---|---|
| | Strength | | 152 Ksi 0.2% Yield Strength | |
| | | Noble Metal | | Noble Metal |
| | Control | Treated | Control | Treated |
| 200 ppb O₂ | 0.35 | 0.08 | 0.35, 0.28, 0.20 | 0.32, 0.45 |
| 95 ppb H₂ | 0.003 | | 0.006 | |
| 8.2 ppm O₂ | | 0.0069 | | 0.002 |
| 1.26 ppm H₂ | | | | |

The results clearly show that the noble metal treated components significantly reduced the amount of hydrogen needed to mitigate stress corrosion cracking by catalytic recombination of oxygen with hydrogen. The crack growth rate was significantly reduced by catalytically lowering the amount of oxygen present in the water. Uncoated compact tension specimens were most susceptible to stress corrosion cracking or required higher amounts of reducing agent to mitigate the crack growth rate.

FIG. 4 graphically summarizes crack growth rates as a function of corrosion potential. At low corrosion potentials, coating the metal component with the noble metal catalyst further reduced the crack growth rate even though the amount of oxidant (oxygen) was much greater in the case of the coated metal specimens compared to the uncoated metal components. At the higher corrosion potentials (higher concentration of oxygen, no reductant), the higher yield strength material exhibited greater crack growth rates, which is consistent with the literature.

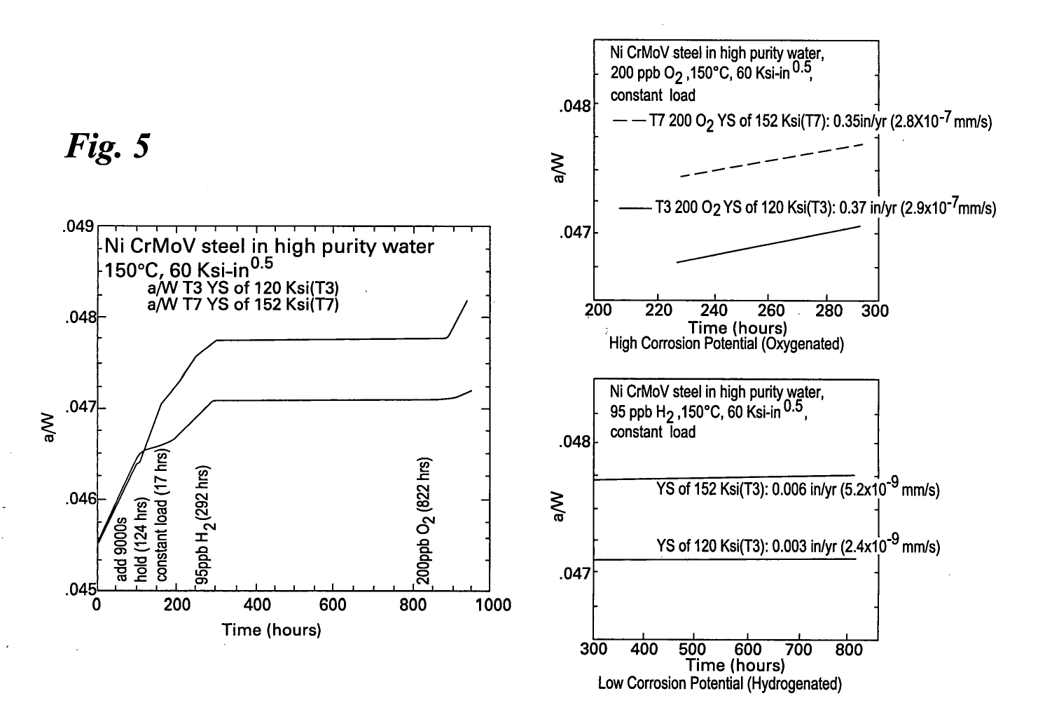

FIG. 5 graphically illustrates the change in crack length with time for uncoated compact tension specimens exposed to varying concentrations of dissolved oxygen (200 ppb) or dissolved hydrogen (95 ppb). The crack growth rate at high corrosion potential conditions (200 ppb oxygen) was 0.37 inches/year for the uncoated compact tension specimens having a 0.2% yield strength of 120 Ksi and 0.35 inches/year for the compact tension specimens having a 0.2% yield strength of 152 Ksi. Hydrogen in the amount of 95 ppb was required to promote low corrosion potential environment sufficient to reduce the crack growth rate to 0.006 inches per year for the 152 Ksi 0.2% yield strength material and 0.003 inches/year for the 120 Ksi 0.2% yield strength compact tension specimens.

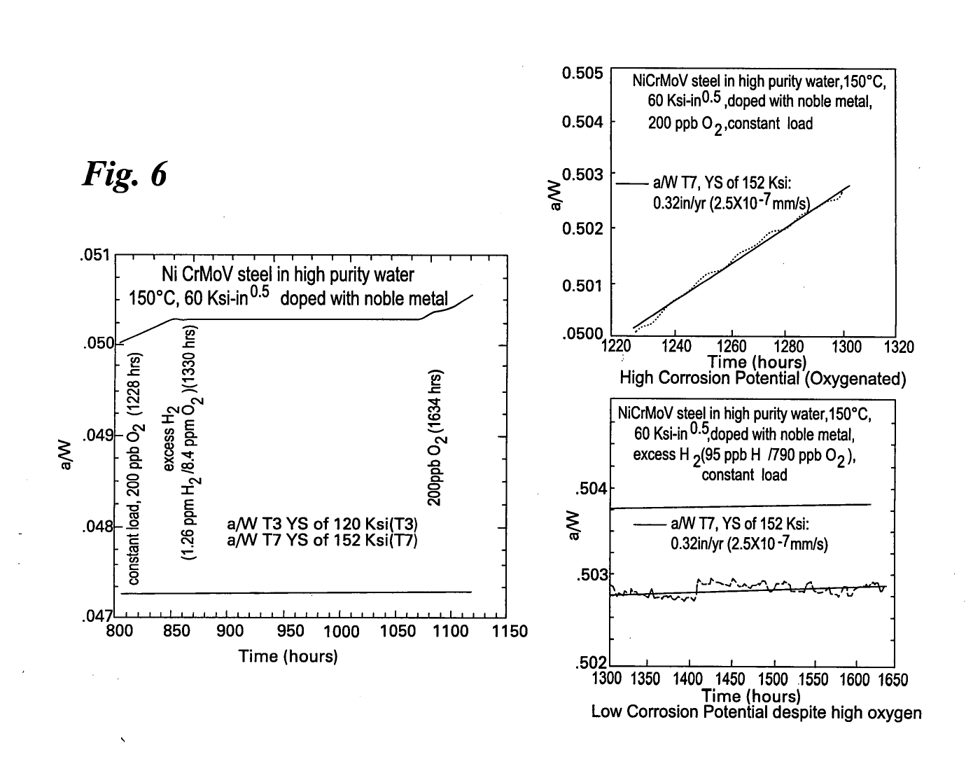

FIG. 6 graphically illustrates the change in crack length with time for noble metal coated compact tension specimens exposed to varying concentrations of dissolved oxygen (200 ppb) or oxygen and hydrogen (two degrees are shown, 8.4 ppm and 1.26 ppm, and 95 ppb hydrogen and 790 ppb oxygen). For the high tensile strength specimen (152 Ksi), under,2high corrosion potential conditions, the crack growth rate was measured to be 0.32 inches/year. However, the crack growth rate was measured to be 0.002 inches per year when the environment contains a reductant despite a high oxygen concentration. In this case, the concentration of hydrogen was 95 ppb and the concentration of oxygen was 790 ppb, thereby indicating significant catalytic activity resulting in a significant reduction of the corrosion potential.

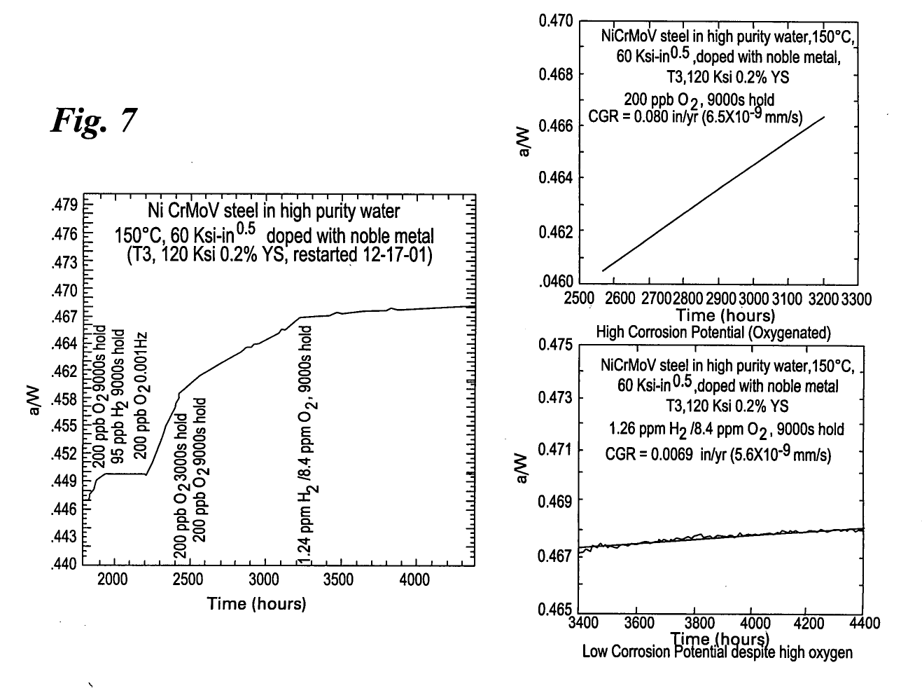

FIG. 7 graphically illustrates graphically illustrates the change in crack length with time for noble metal coated compact tension specimens. The lower tensile strength material exhibited a crack growth rate of 0.080 inches per year under high corrosion potential conditions (200 ppb oxygen). In contrast, the uncoated specimen (see FIG. 4) exhibited a crack growth rate of 0.35 inches per year. Moreover, it is evident that the addition of 1.26 ppm hydrogen to water containing 8.4 ppm oxygen, reduces the corrosion potential as indicated by the reduced crack growth rate of 0.0069 inches per year.

Advantageously, the present disclosure mitigates stress corrosion cracking by modifying the solution chemistry through a reduction in oxygen content. The catalytic noble metal coating catalyzes the recombination of oxygen with a reductant. If there is already sufficient reductant in the system, the present disclosure only requires an application of a trace amount of the noble metal to the regions of concern.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method for mitigating stress corrosion cracking in a surface of a metal component, comprising:
creating a catalytic site on the surface of the metal component; and
exposing the surface of the metal component to a steam environment, wherein the surface comprises catalytic sites and wherein the metal component is used in a steam turbine.

2. The method according to claim 1, further comprising:
adding a reductant to the steam environment.

3. The method according to claim 1, wherein the catalytic site is formed from a platinum group metal.

4. The method according to claim 3, wherein the platinum group metal comprises platinum, palladium, ruthenium, iridium, osmium, rhodium, or combinations comprising at least one of the foregoing metals.

5. The method according to claim 1, wherein the catalytic site is formed by electroless plating of a platinum group metal onto the surface of the metal component.

6. The method according to claim 1, wherein the catalytic site is formed by a process comprising plasma spraying, flame spraying, chemical vapor deposition, physical vapor deposition processes, welding, electroless plating, or electrolytic plating.

7. The method according to claim 1, wherein the catalytic site is formed by deposition of nanoparticles.

8. The method according to claim 1, wherein reducing the concentration of the oxidant in the steam environment reduces the crack growth rate of the component,

9. The method according to claim 1, wherein exposing the surface of the metal component to the steam environment reduces a concentration of an oxidant in the steam environment.

10. The method according to claim 1, wherein exposing the surface of the metal component to the steam environment reduces a corrosion potential of the steam environment.

11. The method according to claim 1, wherein the steam environment has a temperature less than a supercritical temperature of water.

12. The method according to claim 1, wherein the steam environment has a temperature less than about 150° C.

13. The method according to claim 1, wherein the metal component comprises a martensitic composition.

14. A method for mitigating stress corrosion cracking in a surface of a martensitic metal component adapted for use in steam turbines, comprising:
injecting a solution or a suspension of nanoparticles of a platinum group, an alloy of the platinum group metal, a compound of the platinum group metal, or a combination thereof into a steam environment;
firming catalytic sites in the steam environment; and
reducing a concentration of oxidant in the steam environment.

15. The method according to claim 14, wherein reducing the concentration of the oxidant in the steam environment comprises catalyzing a recombination of the oxidant with a reducing agent.

16. The method according to claim 15, wherein the reducing agent comprises hydrogen.

17. The method according to claim 14, wherein the platinum group metal compound comprising platinum, palladium, ruthenium, iridium, osmium, rhodium, or combinations comprising at least one of the foregoing metals.

18. The method according to claim 14, wherein reducing the concentration of oxidant in the steam environment reduces a crack growth rate in the metal component.

19. The method according to claim 14, wherein the metal component comprises a steam turbine rotor or a steam turbine bucket.

20. The method according to claim 14, wherein the steam environment has a temperature less than about a supercritical point of water.

21. The method according to claim 14, wherein the steam environment has a temperature less than about 150° C.

22. The method according to claim 14, wherein the metal component comprises an alloy of an iron-based alloy or a nickel-base alloy.

23. The method according to claim 14, wherein the metal component comprises steels, austenitic stainless steels, martensitic steels, martensitic stainless steels, precipitation hardened stainless steels, or nickel-base superalloys.

24. The method according to claim 14, wherein the metal component comprises an alloy comprising iron, nickel, chromium, molybdenum, vanadium, or combinations comprising at least one of the foregoing metals.

25. The method according to claim 14, wherein the platinum group metal compound is injected into the steam environment in an amount sufficient to produce a noble metal concentration of about 5 to about 100 ppb.

26. A steam turbine comprising:
components formed from a metal having a surface comprising catalytic sites for reducing a concentration of an oxidant in a steam environment.

27. The steam turbine of claim 26, wherein the catalytic sites comprises a platinum group metal selected from the group consisting of platinum, palladium, rhodium, iridium, osmium, ruthenium, and combinations comprising at least one of the foregoing metals.

28. The steam turbine of claim 26, wherein the steam environment has a temperature is less than about 150° C.
